(19) United States
(12) Patent Application Publication
(10) Pub. No.: US 2009/0214069 A1
(43) Pub. Date: Aug. 27, 2009

(54) Multi color headsets

(76) Inventor: Evon E. Plummer, Bronx, NY (US)

Correspondence Address: EVON PLUMMER, 972 E178 STREET U10, BRONX, NY, 10460, US

(21) Appl. No.: 12/071,846

(22) Filed: Feb. 27, 2008

(51) Int. Cl. H04R 1/10

(52) U.S. Cl. 381/370

(57) ABSTRACT

I observe music listeners on the subway of New York City, and I realize people come From different Ethnic background but their portable Music Player has only one solid Color. The increase popularity of various players it would be nice to offer Multi-Color Headsets.

### BRIEF DESCRIPTION OF THE DRAWINGS

FIG. 1 is a perspective view showing one embodiment of the invention.

FIG. 2 is a perspective view showing a second embodiment of the invention.

FIG. 3 is a detail perspective view showing a third embodiment of the invention.

### DETAILED DESCRIPTION OF THE INVENTION

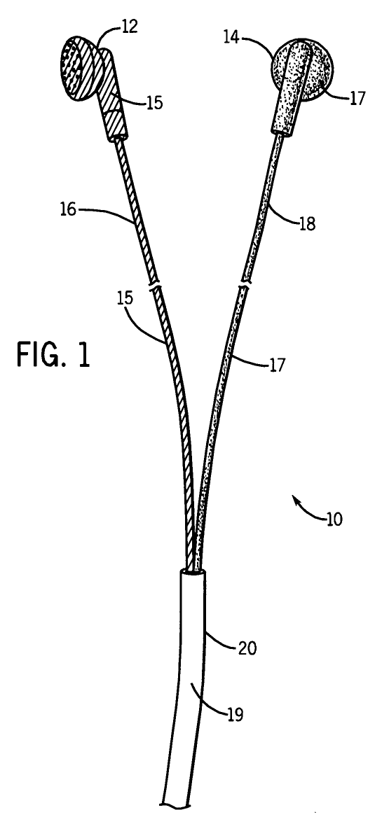

In FIG. 1, a headset 10 is shown with audio listening device 12 connected to insulated wire 16, and audio listening device 14 connected to insulated wire 18. Wires 16 and 18 are encased in sheath 20 which leads to an audio source (not shown). Wires 16 and 18 separate from sheath 20 to connect with audio listening devices 12 and 14, respectively.

The diagonal line pattern indicates a first color 15 on audio listening device 12 and on insulated wire 16. Likewise, stippling indicates a second color 17 on audio listening device 14 and on insulated wire 18. The absence of marking on sheath 20 does not indicate an absence of color, but in the context of the color indications specified above, and in contrast to the first and second colors, the sheath may be of a third color 19. “Colors” in this case may be black and white, or no color at all, as in the case of transparent insulation on one of the wires. Further, “color” could be construed to mean a pattern or any other indicia on each of the elements specified above, for example, a pattern of stars, or stripes, or a combination of, say, white stars with a blue background color, or any other combination of colors or patterns imaginable.

The distinction here is that each of colors 15, 17, and 19 are visually and distinctively different from the other two.

The colors may be used to indicate the colors of a national flag. For example, in FIG. 1 the first color 15 could be red, the second color 17 could be blue and the third color 19 could be white, the colors of the American flag. Or the colors 15, 17, and 19 could be green, yellow, and black, respectively, the colors of the Jamaican flag. The colors may be chosen simply as a visually pleasing combination as well with no other meaning.

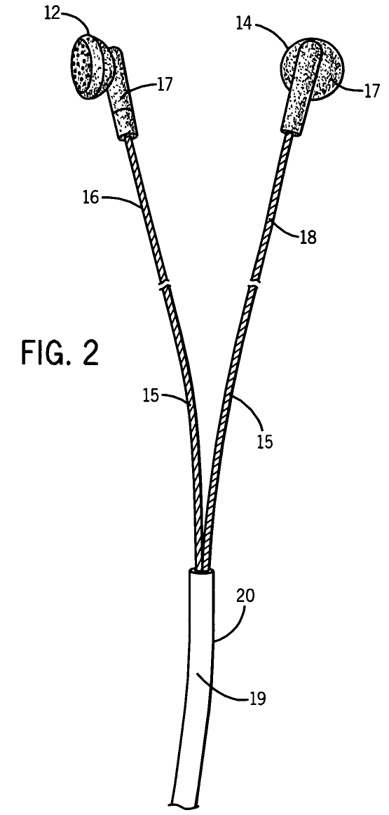

Referring to FIG. 2, all the elements are the same as in FIG. 1, the difference being that in this embodiment color 15 is on both wires 16 and 18, color 17 is on both audio listening devices 12 and 14, and color 19 remains on sheath 20. It is understood that color 19 could have been placed on wires 16 and 18, or on audio listening devices 12 and 14 as well.

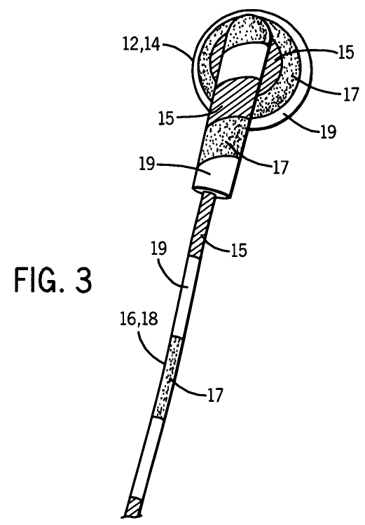

In FIG. 3, wire 16,18 and audio listening device 12,14 are all colored in alternating patterns of color. Although not shown, sheath 20 may also be colored in similar patterns.

Audio listening devices 12,14 may be in the form of ear buds, as shown in the Figs., or they may be headphones, or any other device designed for listening to an audio signal.

To the best of my knowledge this description does not contain new matter (Aug. 11, 2008)

1. I claim exclusive rights to design Multi-Color Headsets and attached wires for all Portable Music Players that reflect National Flags; comprise of colors and designs that Identifies National Origins.
